(19) United States
(12) Patent Application Publication
(10) Pub. No.: US 2014/0244402 A1
(43) Pub. Date: Aug. 28, 2014

(54) SYSTEM FOR SELECTIVELY DISPLAYING CONTENT

(71) Applicant: Google Inc., (US)

(72) Inventors: Arnold Binas, Kirribilli (AU); Andrew D. FOSTER, Naremburn (AU); Jordan BAYLISS-MCCULLOCH, Beaconsfield (AU); Alexander M. BERRY, Pyrmont (AU); Robert J. BOWMAKER, Balmain (AU)

(73) Assignee: Google Inc., Mountain View, CA (US)

(21) Appl. No.: 13/777,948

(22) Filed: Feb. 26, 2013

(51) Int. Cl. G06F 3/0481

(52) U.S. Cl. CPC G06F 3/0481
USPC 705/14.69; 715/771; 705/14.73

(57) ABSTRACT

A system for selectively displaying content may include one or more processors and a memory. The one or more processors may display a graphical object at a first location on a map, determine a user interaction with the graphical object, and display, in response to the determining, a first content item on the map at a second location that is proximal to the first location, the first content item being associated with the graphical object. The one or more processors may identify a selection of the graphical object and display, in response to the identifying, a second content item on the map at a third location that is disparate from the first and second locations, the second content item being associated with the first content item and the graphical object. The one or more processors may transmit an indication of the selection of the graphical object.

### TECHNICAL FIELD

The present description relates generally to displaying content, and more particularly, but not exclusively, to selectively displaying content.

### BACKGROUND

Online services, such an online map service, may provide a user with streamlined access to information that may be used to perform one or more offline tasks. For example, a user may use an online map service to search for a business, and the online map service may provide the user with streamlined access to contact information for the business (e.g., telephone number, address, etc.) without requiring the user to navigate to the business's web page. The user may then use the contact information of the business to perform one or more offline tasks that may be beneficial to the business, e.g. contacting the business via telephone and/or visiting the physical location of the business. Although the online map service provider may have been compensated by the business if the user had been required to navigate to the business's web page to access the contact information of the business, e.g. in the form a click-through, the online map service provider may not be compensated by the business for providing the user with streamlined access to the contact information of the business, even though the business may still benefit from the user having streamlined access to such information.

### SUMMARY

The disclosed subject matter relates to a computer implemented method for selectively displaying content. The method may include displaying, using one or more computing devices, a graphical object at a first location on a map and determining, using the one or more computing devices, a user interaction with the graphical object. The method may further include displaying, using the one or more computing devices and in response to the determining, a first content item on the map at a second location that is proximal to the first location, wherein the first content item is associated with the graphical object. The method may further include identifying, using the one or more computing devices, a selection of the graphical object, and displaying, using the one or more computing devices and in response to the identifying, a second content item on the map at a third location that is disparate from the first and second locations, wherein the second content item is associated with the first content item and the graphical object. The method may further include transmitting an indication of the selection of the graphical object.

The disclosed subject matter also relates to a computer implemented method for providing selectively displayable content. The method may include providing, using one or more computing devices, a graphical object to be displayed on a map and first and second content items that are associated with the graphical object, the first content item to be displayed on the map proximal to the graphical object and the second content item to be displayed on the map disparate from the graphical object and the first content item, wherein the second content item is to be displayed exclusively in response to a selection of the graphical object by a user. The method may further include receiving, using the one or more computing devices, an indication of the selection of the graphical object by the user, and storing, using the one or more computing devices, the indication of the selection of the graphical object by the user.

The disclosed subject matter also relates to a system for selectively displaying content. The system may include one or more processors and a memory including instructions that, when executed by the one or more processors, cause the one or more processors to: receive an advertisement and a content item, wherein the advertisement is associated with the content item, display the advertisement on a web page, identify a selection of the advertisement, display, in response to the identify, the content item on the web page, wherein the content item is displayed non-adjacent to, and non-overlapping with, the advertisement, and transmit, in response to the selection, an indication of a click-through of the advertisement.

The disclosed subject matter also relates to a non-transitory machine-readable medium embodying instructions that, when executed by a machine, allow the machine to perform a method for selectively displaying content. The method may include receiving a graphical object and first and second content items associated with the graphical object. The method may further include displaying the graphical object on a map, and displaying the first content item on the map proximal to the graphical object. The method may further include identifying a selection of the graphical object, and displaying, in response to the identifying, the second content item on the map disparate from the graphical object and the first content item.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment that may implement a system for selectively displaying content in accordance with one or more implementations.

FIG. 2 illustrates a flow diagram of an example process for a system for selectively displaying content in accordance with one or more implementations.

FIG. 3 illustrates a flow diagram of an example process for a system for providing selectively displayable content in accordance with one or more implementations.

FIG. 4 illustrates an example user interface for a system for selectively displaying content in accordance with one or more implementations.

FIG. 5 illustrates an example user interface for a system for selectively displaying content in accordance with one or more implementations.

FIG. 6 illustrates an example user interface for a system for selectively displaying content in accordance with one or more implementations.

FIG. 7 conceptually illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In some instances, structures and components are shown in block diagram form in order to avoid obscuring the concepts of the subject technology.

I. Overview

In the subject system for selectively displaying content, a graphical object associated with a business may be displayed on a map to a user. In one or more implementations, the graphical object may include only text, such as a name of the business. Alternatively, or in addition, the graphical object may be an advertisement for the business, or the graphical object may be a graphical indicator that is used by the online map service to indicate business locations on a map. In one or more implementations, the graphical object may be exclusive of at least one contact information item pertaining to the business, such as the phone number of the business, the address of the business, etc. The subject system may identify when a user selects the graphical object, such as by clicking on the graphical object. In response to the user selecting the graphical object, the subject system may display on the map one or more contact information items pertaining to the business, such as the telephone number of the business, the physical address of the business, etc. The subject system may also store an indication of the user's selection of the graphical object. In one or more implementations, the business may be charged for the user's selection of the graphical object, e.g. in the form of a click-through.

Thus, the subject system for selectively displaying content allows an online map service provider to be compensated for providing streamlined access to contact information of a business, e.g. without requiring that a user clicks-through to the web page of the business. The subject system may also be beneficial to a user performing an offline task with contact information of a business that was obtained from an online map service, such as contacting a business via telephone. For example, if upon contacting a business via telephone the user determines that the business does not meet their needs, e.g. the business is closed, the user can return to the online map service and have immediate streamlined access to contact information of another business. Similarly, the subject system may be beneficial to the online map service provider in such instances by allowing the online map service provider to receive compensation for providing the user with streamlined access to contact information of another business.

In the instance where the graphical object is a graphical indicator that is used by an online map service to indicate the location of a business, the subject system may also display an advertisement for the business, or other basic information pertaining to the business (e.g., exclusive of the phone number and/or address of the business), when a user interacts with the graphical object without selecting the graphical object, e.g. hovering over the graphical object. This basic information may convey to the user that the online map service provider may be compensated if the user clicks on the graphical object. The basic information may be displayed on the map at a location that is proximal to the graphical object, e.g. adjacent to, and/or overlapping with, the graphical object. If the subject system determines that the user clicked on the graphical object, the subject system may display the contact information of the associated business on the map at a location that is disparate from both the basic information and the graphical object, e.g. non-adjacent to, and non-overlapping with, the basic information and the graphical object. In one or more implementations, the contact information may be displayed on the same web page as the map, but non-overlapping with the map, e.g. outside of the map.

In one or more implementations, the manner and/or amount in which a business is charged for a selection of a graphical object by a user may be determined based at least in part on how the user interacts with the contact information. For example, in the context of a mobile device, a user may be able to click on the phone number of the business to initiate a call to the business. In this instance, the subject system may charge the business an additional amount, e.g. if the system can determine that the user initiated a call to the business and/or that the user's call was answered by the business. Similarly, in the context of a mobile device, a user may be able to request turn-by-turn directions to the business's physical location. In this instance, the subject system may also charge an additional amount to the business, e.g. if the system can determine that the user navigated to, or started to navigate to, the business's physical location.

II. Example Network Environments for a System for Selectively Displaying Content

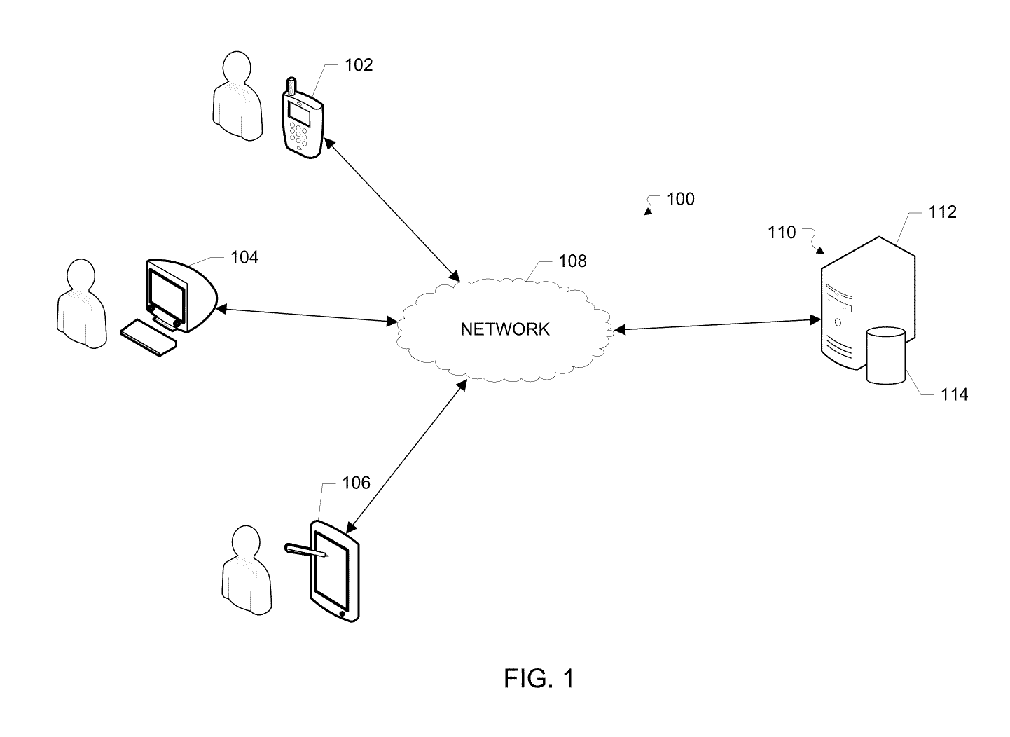

FIG. 1 illustrates an example network environment 100 which may implement a system for selectively displaying content in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The network environment 100 may include a number of electronic devices 102, 104, 106 communicably connected to a server 110, such as by the network 108. In another example, some or all of the electronic devices 102, 104, 106 may be communicably connected to one another, such as by the network 108, and some or all of the electronic devices 102, 104, 106 may not be communicably connected to the server 110. The network 108 may be a public communication network (such as the Internet, cellular data network, dialup modems over a telephone network) or a private communications network (such as private local area network (“LAN”), leased lines). The network 108 may also include, but is not limited to, any one or more of the following network topologies, including a bus network, a star network, a ring network, a mesh network, a star-bus network, a tree or hierarchical network, and the like.

In some example embodiments, the electronic devices 102, 104 and 106 can be computing devices such as laptop or desktop computers, smartphones, personal digital assistants (“PDAs”), portable media players, tablet computers, televisions or other displays with one or more processors coupled thereto and/or embedded therein, or other appropriate computing devices that can be used to for displaying a web page or web application, such as a web page or a web application that selectively displays content. In the example of FIG. 1, the electronic device 102 is depicted as a smartphone, the electronic device 104 is depicted as a desktop computer, and the electronic device 106 is depicted as a tablet device.

In one example, server 110 may be a single computing device such as a computer server. In another example, server 110 may represent one or more computing devices (such as a cloud of computers and/or a distributed system) that are communicatively coupled, such as communicatively coupled over the network 108, that collectively, or individually, perform one or more functions that can be performed server-side, such as search result retrieval, advertising content retrieval, advertising content serving, and/or generally any functions that can be performed server-side. The one or more computing devices of the server 110 may be geographically collocated and/or the one or more computing devices of the server 110 may be disparately located. The server 110 may be coupled with various databases, storage services, or other computing devices. The server 110, and the coupled databases, storage services, or other computing devices may be geographically collocated, or may be disparately located.

In one or more implementations, the server 110 includes a processing device 112 and a data store 114. The processing device 112 executes computer instructions stored in the data store 114, for example, to provide selectively displayable content to one or more of the electronic devices 102, 104, 106. In one or more implementations, the data store 114 may store the computer instructions on non-transitory computer-readable medium.

The server 110 may host a web server that is communicatively coupled to client devices, such as web browsers of client devices (e.g., electronic devices 102, 104 or 106) via network 108. In one example, the subject system may be integrated into one or more of a search engine, a map engine, an advertising content retrieval system and/or an advertising content serving system hosted at server 110. In another example, the subject system may be hosted at server 110 and may be communicatively coupled to one or more remote servers hosting one or more other search engines, map engines, advertising content retrieval systems and/or advertising content serving systems (e.g., one or more remote servers) over one or more networks (e.g., network 108).

III. Example Processes for a System for Selectively Displaying Content

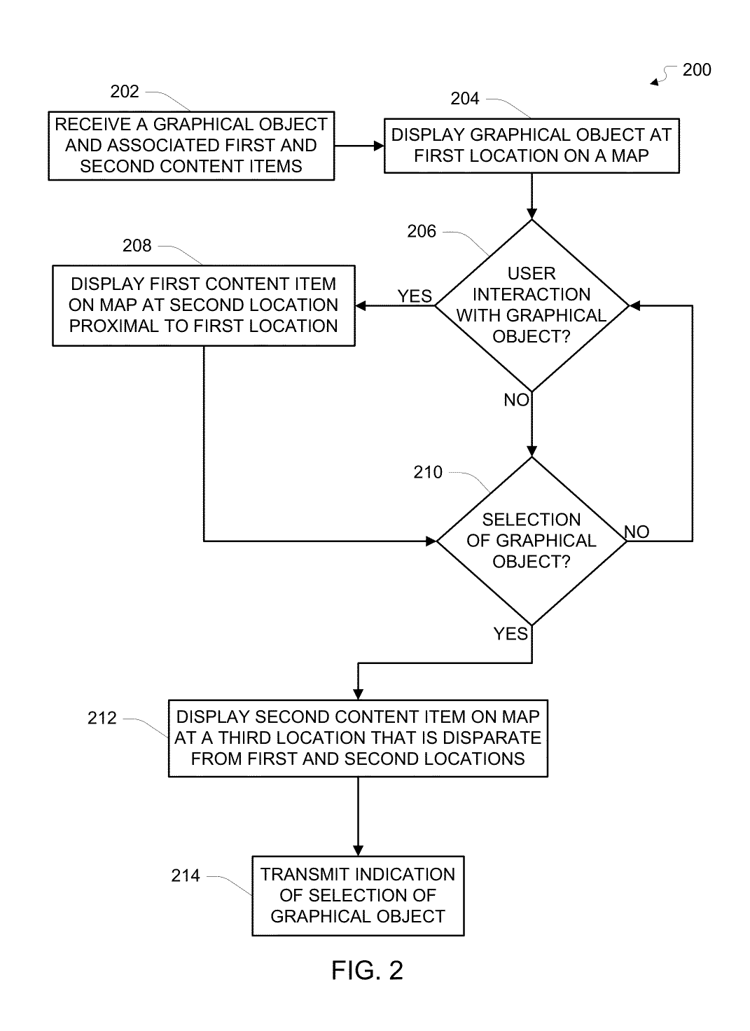

FIG. 2 illustrates a flow diagram of example process 200 for selectively displaying content in accordance with one or more implementations. For explanatory purposes, example process 200 is described herein with reference to example network environment 100 of FIG. 1; however, example process 200 is not limited to example network environment 100 of FIG. 1. Further for explanatory purposes, the blocks of example process 200 are described herein as occurring in serial, or linearly. However, multiple blocks of example process 200 may occur in parallel. In addition, the blocks of example process 200 need not be performed in the order shown and/or one or more of the blocks of example process 200 need not be performed.

In block 202, one of the electronic devices 102, 104, 106, such as the electronic device 102, receives a graphical object and associated first and second content items, such as from the server 110. For example, the electronic device 102 may be displaying a map to a user, or may be preparing to display a map to the user, and the graphical object may be an object that is displayed on the map to indicate a location of a business. In one or more implementations, the server 110 may provide one or more objects for display on the map and/or may provide one or more advertisements for display on the map. The graphical object may include one or more of text and/or graphics corresponding to an associated business. In one or more implementations, the graphical object may be an indicator of a place of business, such as a pin, and/or the graphical object may include text, such as the name of the associated business. Alternatively, or in addition, the graphical object may include graphical characteristics, such as a particular color, and/or textual indicators, such as the word “Ad,” that indicate that the graphical object is associated with an advertisement. In one or more implementations, the first content item may be an advertisement for the business that is associated with the graphical object, while the second content item may include information pertaining to the business that is associated with the graphical object, such as the address of the business, the telephone number of the business, etc.

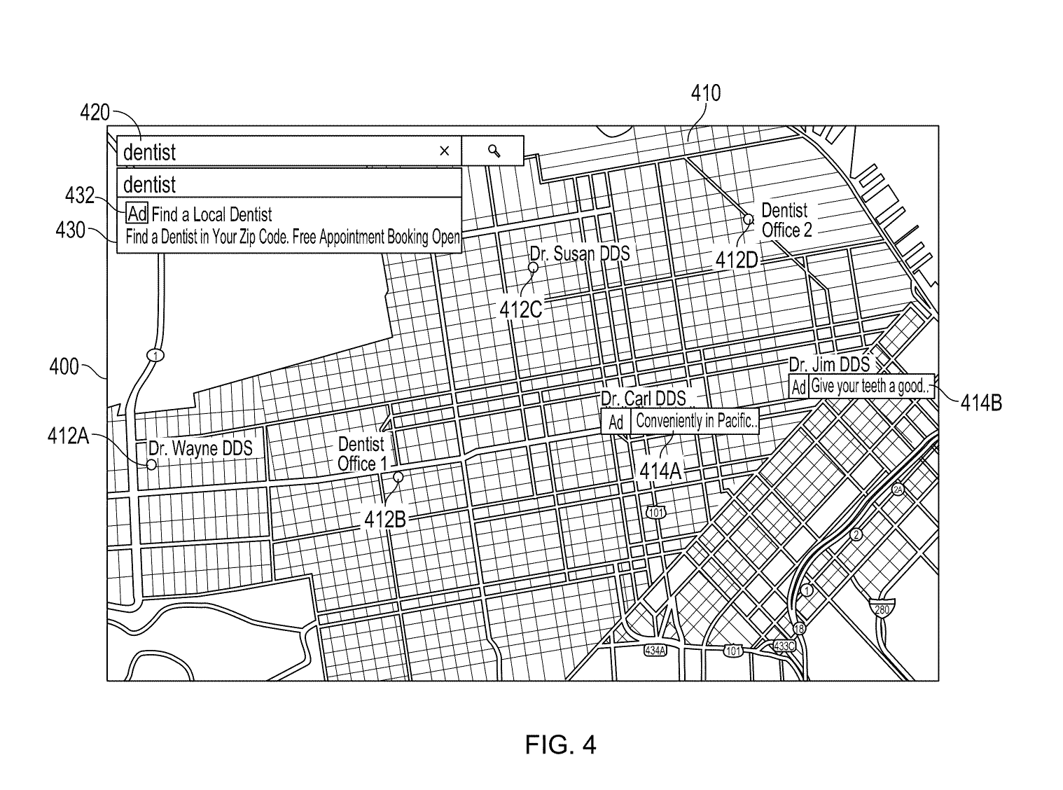

In block 204, the electronic device 102 may display the graphical object at a first location on the map, such as a location on the map that corresponds to the geographical location of the business that is associated with the graphical object. In one or more implementations, the location of the graphical object on the map be identified by geographic coordinates, e.g. a geographic location that is displayed on the map, and/or by pixel coordinates, e.g. a relative position of the graphical object on the image of the map and/or on the web page. An example of a graphical object that is displayed on a map is shown in FIG. 4 and is discussed further below with respect to FIG. 4. In block 206, the electronic device 102 determines whether a user interacted with the graphical object exclusive of selecting the graphical object, such as by hovering a pointing indicator over the graphical object. For example, a hover event may be generated when the user hovers a pointing indicator over the graphical object and/or performs one or more touch gestures with respect to the graphical object. If, in block 206, the electronic device 102 determines that the user interacted with the graphical object, the electronic device 102 moves to block 208.

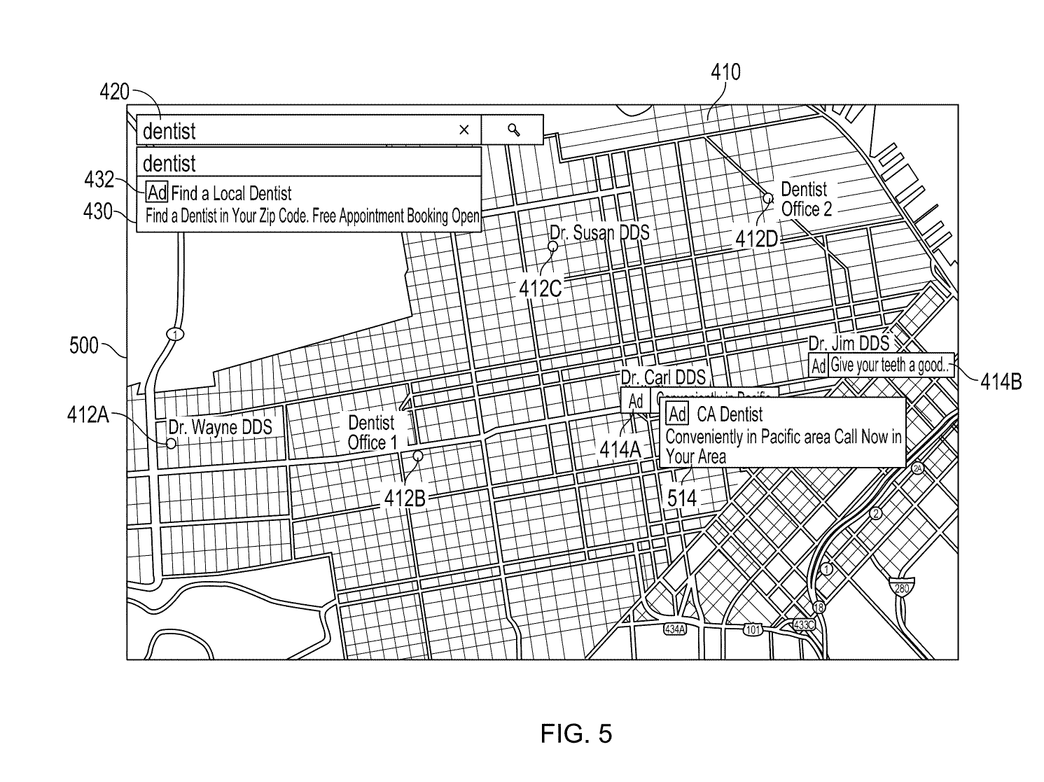

In block 208, the electronic device 102 displays the first content item on the map at a second location that is proximal to the first location. In one or more implementations, the first content item may be displayed on the map adjacent to, near to, and/or overlapping with the graphical object. As previously discussed, the first content item may be an advertisement for the business associated with the graphical object and may include one or more of graphics and/or text. In one or more implementations, the first content item may be exclusive of at least one contact information item corresponding to the associated business, such as a telephone number, address, etc. In one or more implementations, the electronic device 102 may display the first content item to the user exclusively while the user interaction, such as hover event, is occurring, e.g. while the pointing indicator is hovering over the graphical object. An example of a first content item displayed on a map is shown in FIG. 5, and is discussed further below with respect to FIG. 5. In one or more implementations, if the first content item includes an advertisement, the business associated with the advertisement may not be charged for the display of the first content item to the user, e.g. in response to the user interaction. Alternatively, or in addition, the business may be charged a fee for the display of the first content item to the user, e.g. in response to the user interaction.

If, in block 206, the electronic device 102 did not detect a user interaction with the graphical object, the electronic device 102 moves to block 210. In block 210, the electronic device 102 identifies whether the user selected the graphical object. For example, the user may select the graphical object by clicking on the graphical object. If, in block 210, the electronic device 102 does not identify a selection of the graphical object by the user, the electronic device 102 returns to block 206 and determines whether a user interaction, exclusive of a selection, has occurred. If, in block 210, the electronic device 102 identifies that a selection of the graphical object has occurred, e.g. the user clicked on the graphical object, the electronic device 102 moves to block 212.

In block 212, the electronic device 102 displays the second content item on the map at a third location that is disparate from the first and second locations. For example, the electronic device 102 may display the second content item such that it is non-adjacent to, and non-overlapping with, the graphical object and the first content item. In one or more implementations, the second content item may include information for contacting the business that is associated with the first content item and the graphical object. For example, the second content item may include one or more of an address of the business, a telephone number of the business, a network identifier, such as a uniform resource location (URL) that is associated with the business, an email address of the business, or generally any information that may be used to contact the business. Accordingly, in one or more implementations, the second content item, and the contact information contained therein, may be displayed to the user exclusively in response to the user selecting the graphical object. Thus, the user may be unable to view the contact information for the business without selecting the graphical object.

In block 214, the electronic device 102 transmits an indication of the selection of the graphical object, such as to the server 110. In one or more implementations, the indication may be indicative of a click-through by the user to the web page of the business associated with the graphical object, irrespective of whether the user clicked through to a web page of the business. The server 110 may use the indication to charge a fee to the business that is associated with the graphical object and the first and second content items, e.g. similar to the manner in which the business would be charged for a click-through.

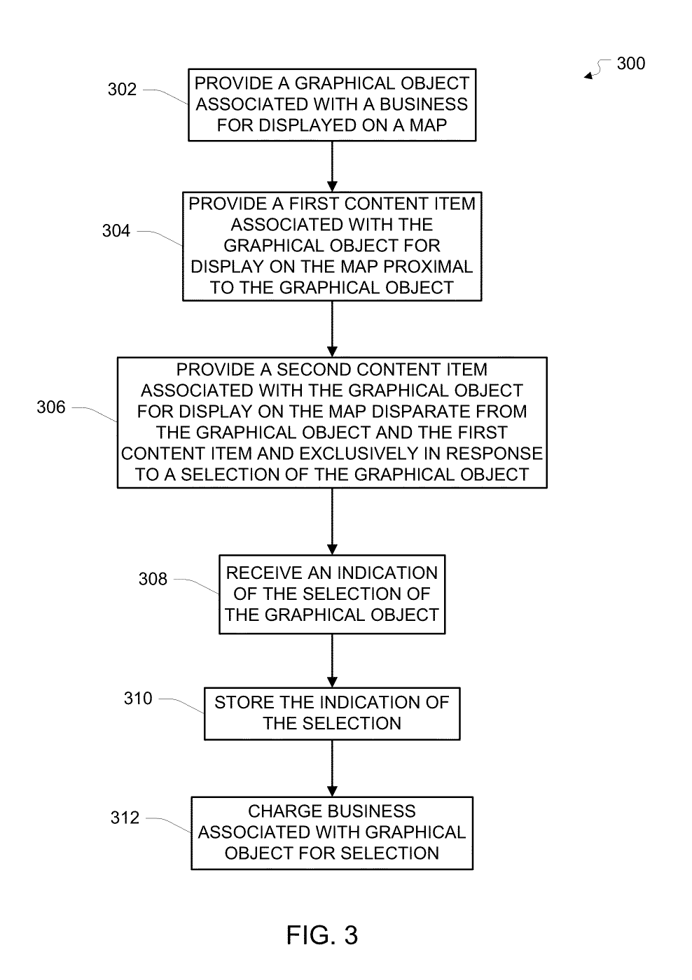

FIG. 3 illustrates a flow diagram of example process 300 for selectively displaying content in accordance with one or more implementations. For explanatory purposes, example process 300 is described herein with reference to example network environment 100 of FIG. 1; however, example process 300 is not limited to example network environment 100 of FIG. 1. Further for explanatory purposes, the blocks of example process 300 are described herein as occurring in serial, or linearly. However, multiple blocks of example process 300 may occur in parallel. In addition, the blocks of example process 300 need not be performed in the order shown and/or one or more of the blocks of example process 300 need not be performed.

In block 302, the server 110 provides a graphical object that is associated with a business for display on a map. For example, the server 110 may provide the electronic device 102 with a graphical object for display on a map, such as a map that is being displayed to a user, or is being prepared for display to a user, by the electronic device 102. In one or more implementations, the business that is associated with the graphical object may have previously identified the location on the map where the graphical object will be displayed. For example, the business may select the location on the map that corresponds with a geographic location of the business, the business may select a location on the map that corresponds with a geographic location where the business would like to attract new customers, or the business may generally select any location on the map to display the graphical object. Alternatively, or in addition, the graphical object may exclusively be displayed on the map at a geographic location corresponding to the associated business.

In block 304, the server 110 provides, e.g. to the electronic device 102, a first content item for display on the map at a location that is proximal to the graphical object, where the first content item is associated with the graphical object. In one or more implementations, the first content item may be displayed on the map contemporaneous to the display of the graphical object. Alternatively, or in addition, the first content item may be displayed in response to an identification of a user interaction event that is associated with the graphical object, such as a hover event. In one or more implementations, the first content item may be an advertisement for the business that is associated with the graphical object, such as a search advertisement, a display advertisement, or generally any advertisement. In one or more implementations, the first content item may be exclusively of at least one contact information item corresponding to the associated business.

In block 306, the server 110 provides, e.g. to the electronic device 102, a second content item for display on the map at a location that is disparate from the graphical object and the first content item, where the second content item is associated with the graphical object and the first content item. The second content item may be provided to the electronic device 102 such that the electronic device 102 may display the second content item exclusively in response to a selection of the graphical object, such as by a user. In one or more implementations, the second content item may include information pertaining to the business that is associated with the graphical object, such as contact information, e.g. a phone number, a mailing address, a network identifier, an email address, etc. Thus, in one or more implementations, the user may be unable to view at least one contact information item for the business without selecting the graphical object.

In block 308, the server 110 receives, e.g. from the electronic device 102, an indication of a selection of the graphical object, such as by a user. For example, a user may interact with the electronic device 102 to select the graphical object, such as by tapping on the graphical object, clicking on the graphical object, etc. In response to the selection of the graphical object by the user, the electronic device 102 may communicate the indication of the selection of the graphical object to the server 110. In block 310, the server 110 stores the indication of the selection of the graphical object by the user, such as in the data store 114.

In block 312, the server 110 may charge the business that is associated with the graphical object for the selection of the graphical object by the user. For example, on a periodic basis the server 110, or a server associated therewith, such as a billing server, may aggregate all of the received indications of the selections of the graphical objects and may charge a fee to an account of the business for the selections. In one or more implementations, the selections may be charged similar to, or the same as, a click-through. Alternatively, or in addition, other billing arrangements may be used to charge the business for the selections of the graphical object, e.g. to compensate the provider of the map for providing the contact information for the business in response to the selections of the graphical object.

IV. Example User Interfaces for Systems for Selectively Displaying Content

FIG. 4 illustrates an example user interface 400 for a system for selectively displaying content in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The user interface 400 may include a map 410, a search query field 420, and an advertisement area 430. The map 410 may include one or more search results 412A-D and one or more graphical objects 414A-B that are associated with businesses. The advertisement area 430 may display one or more advertisements 432. In one or more implementations, a business that is associated with a graphical object 414A may also be a search result for a search entered in the search query field 420. In these one or more implementations, the graphical object 414A may be displayed for the business rather than one of the search results 412A-D. The user interface 400 may be displayed to a user via any of the electronic devices 102, 104, 106, such as the electronic device 102.

In operation, a user interacting with the electronic device 102 may input a search query into the search query field 420. The electronic device 102 may provide the search query to the server 110, such as via the network 108. The server 110 may retrieve the search results 412A-D and one or more advertisements 432 based at least in part on the query and/or the geographical area that is displayed on the map 410. The server 110 may provide the search results 412A-D and the one or more advertisements 432 to the electronic device 102 for display to the user. For example, the search results 412A-D may correspond to businesses that are located within the geographic area displayed on the map 410 that are related to the search query inputted into the search query field 420. In one or more implementations, a search result 412A may include a graphical indicator, such as a colored circle, and/or a textual indicator that identifies the business, or place, that corresponds to the search result 412A, such as a name of the business or place. The one or more advertisements 432 provided by the server 110 may be displayed in the advertisement area 430. The advertisement area 430 may also display the search query that was entered into the search query field 420.

The server 110 may retrieve the graphical objects 414A-B based at least in part on the search query entered into the search query field 420 and/or the geographic area that is displayed on the map 410. In one or more implementations, the graphical objects 414A-B may be retrieved using algorithms that are similar to, or the same as, those used for retrieving the advertisements 432 corresponding to the search query. Alternatively, or in addition, the graphical objects 414A-B may be displayed on the map at locations that correspond to the physical locations, e.g. mailing addresses, of the associated businesses. In one or more implementations, a graphical object 414A may be, or may include, one or more of the following: text, such as a name of the business, an advertisement for the business, an indicator that is used on the map to indicate a location, or an indicator that is used on the map to indicate an advertisement.

In one or more implementations, when the server 110 provides the graphical objects 414A-B to the electronic device 102, the server 110 may also provide first and second content items that are associated with the graphical objects. The first and second content items may be stored by the electronic device 102 and may be displayed on the map 410 in response to identifying a user interaction with one of the graphical objects 414A-B on the map 410, such as a hover interaction with respect to one of the graphical objects 414A-B, or a selection of one of the graphical objects 414A-B.

FIG. 5 illustrates an example user interface 500 for a system for selectively displaying content in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The user interface 500 may include a map 410, a search query field 420, and an advertisement area 430. The map 410 may include one or more search results 412A-D, one or more graphical objects 414A-B that are associated with businesses, and one or more first content items 514. The advertisement area 430 may include one or more advertisements 432. The user interface 500 may be displayed to a user via any of the electronic devices 102, 104, 106, such as the electronic device 102.

In operation, the user interface 500 may be displayed to a user when the electronic device 102 identifies a user interaction, such as a hover interaction, with respect to one of the graphical objects 414A-B of the user interface 400, such as the graphical object 414A. For example, the electronic device 102 may display the first content item 514 in response to identifying a user interaction, such as a hover interaction, with respect to the graphical object 414A. In one or more implementations, the first content item 514 may be displayed on the user interface 500 at a location that is proximal to the location of the displayed graphical object 414A, such as near the graphical object 414A, adjacent to the graphical object 414A, and/or overlapping with the graphical object 414A. In one or more implementations, a user may interact with a pointing device that is coupled to the electronic device 102 to hover a pointing indicator over the graphical object 414A of the user interface 400. Alternatively, or in addition, the user may trigger a hover event by performing one or more touch gestures with respect to the graphical object 414A. For example, a hover event may be triggered by a tap, a double tap, or generally any touch gestures.

In one or more implementations, the first content item 514 may be, or may include, one or more of the following: an advertisement for the business associated with the graphical object 414A, information pertaining to the business that is associated with the graphical object 414A, a graphical or textual indicator that the graphical object 414A corresponds to an advertisement, and/or all or part of any textual or graphical indicators of the graphical object 414A. In one or more implementations, the server 110 may provide the first content item 514 to the electronic device 102 when the hover event is identified by the electronic device 102, or in advance of the identification of the user interaction by the electronic device 102, such as when the graphical object 414A is provided to the electronic device 102.

For explanatory purposes, the user interface 500 is described as being displayed on the electronic device 102 to a user. However, in one or more implementations, one or more aspects of the user interface 500 may be displayed to the user via the user interface 400, e.g. the one or more first content items 514 of the user interface 500 may be displayed on the user interface 400 without refreshing the entire user interface 400 to display the one or more first content items 514 of the user interface 500.

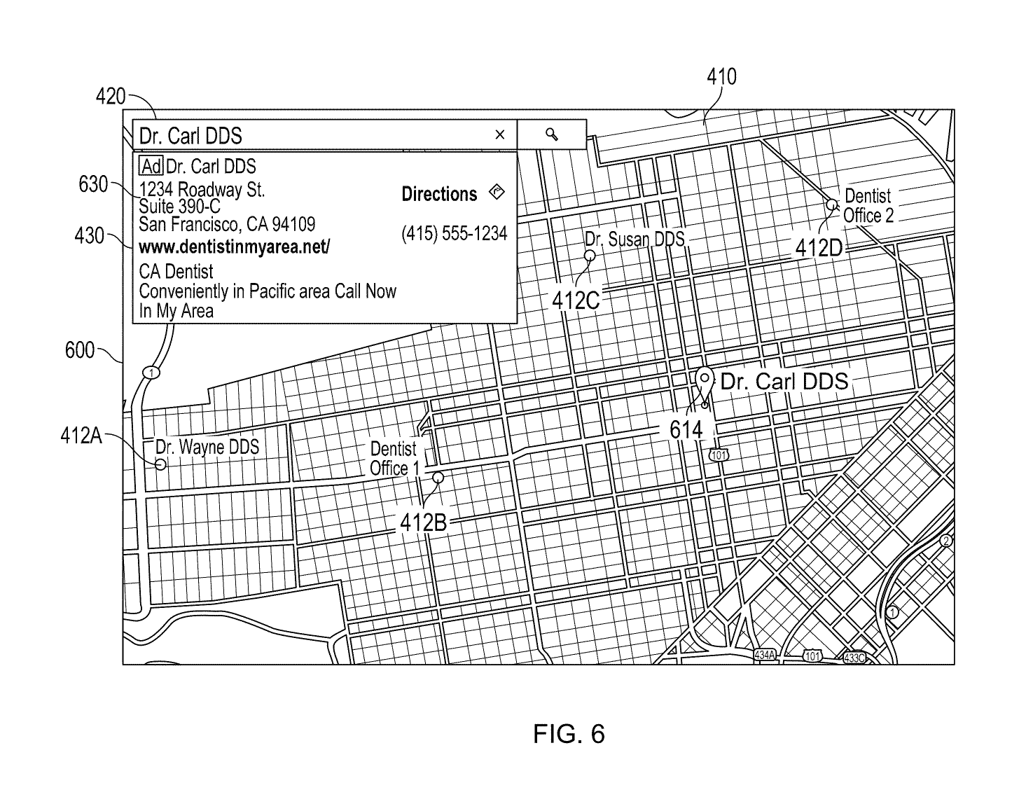

FIG. 6 illustrates an example user interface 600 for a system for selectively displaying content in accordance with one or more implementations. Not all of the depicted components may be required, however, and one or more implementations may include additional components not shown in the figure. Variations in the arrangement and type of the components may be made without departing from the spirit or scope of the claims as set forth herein. Additional, different or fewer components may be provided.

The user interface 600 may include a map 410, a search query field 420, and an advertisement area 430. The map 410 may include one or more search results 412A-D and a selected object indicator 614. The advertisement area 430 may include a second content item 630. The user interface 600 may be displayed to a user via any of the electronic devices 102, 104, 106, such as the electronic device 102.

In operation, the user interface 600 may be displayed to a user when the electronic device 102 identifies a selection with respect to one of the graphical objects 414A-B of the user interface 400 or 500, such as the graphical object 414A. For example, the electronic device 102 may display the second content item 630 in response to identifying a selection by the user of the graphical object 414A of the user interface 400 or 500. The electronic device 102 may display the second content item 630 in the advertisement area 430, e.g. such that the second content item 630 replaces any advertisements 432 that were previously displayed in the advertisement area 430.

In response to identifying a selection of the graphical object 414A of the user interface 400 or 500, the electronic device 102 may also replace the graphical object 414A of the user interface 400 or 500 with the selected object indicator 614 of the user interface 600. The selected object indicator 614 may be, or may include, a graphical indicator that differentiates the selected object indicator 614 from other indicators displayed on the map 410, such as differentiating by color, shape, size, etc. The selected object indicator 614 may also be, and/or may include, an identifier of the selected graphical object 414A of the user interface 400 or 500, such as the name of the business that is associated with the graphical object 414A. Alternatively, or in addition, any text that was displayed in the search query field 420 may be replaced with the identifier of the selected graphical object 414A of the user interface 400 or 500, such as the name of the business that is associated with the graphical object 414A. In one or more implementations, the electronic device 102 may display the second content item 630 without displaying the selected object indicator, e.g. without replacing the graphical object 414A with the selected object indicator 614.

In one or more implementations, the second content item 630 may be displayed on the user interface 600 at a location that is disparate from the location of the displayed selected object indicator 614 and/or from the locations of the displayed graphical object 414A and/or the displayed first content item 514, such as separate from, non-overlapping with, and/or non-adjacent to, the selected object indicator 614 and/or the graphical object 414A and/or the first content item 514. In one or more implementations, a user may interact with a pointing device that is coupled to the electronic device 102 to select the graphical object 414A of the user interface 400. Alternatively, or in addition, the user may select the graphical object 414A by performing one or more touch gestures with respect to the graphical object 414A, such as a tap, a double tap, or generally any touch gesture.

In one or more implementations, the second content item 630 may be, or may include, information corresponding to the business associated with the selected object indicator 614 (and the selected graphical object 414A of the user interface 400 or 500), such as contact information for the business, e.g. a name of the business, a mailing address of the business, a phone number of the business, a URL of the business, or generally any information corresponding to the business associated with the selected object indicator 614. Alternatively, or in addition, the second content item 630 may be, or may further include, a selector for requesting directions to the mailing address of the associated business, an advertisement for the associated business, a graphical or textual indicator that the second content item 630 corresponds to an advertisement for the associated business, and/or all or part of any textual or graphical indicators of the graphical object 414A of the user interface 400 or 500 and/or the first content item 514 of the user interface 500.

In one or more implementations, the server 110 may provide the second content item 630 to the electronic device 102 when the selection of the graphical object 414A of the user interface 400 or 500 is identified by the electronic device 102, or in advance of the identification of the selection of the graphical object 414A of the user interface 400 or 500 by the electronic device 102, such as when the graphical object 414A of the user interface 400 or 500, and/or the first content item 514 of the user interface 500, are provided to the electronic device 102.

For explanatory purposes, the user interface 600 is described as being displayed on the electronic device 102 to a user. However, in one or more implementations, one or more aspects of the user interface 600 may be displayed to the user via the user interface 400 or the user interface 500, e.g. the selected object indicator 614 and/or the second content item 630 of the user interface 600 may be displayed on the user interface 400 or the user interface 500 without refreshing the entire user interface 400 or the entire user interface 500 to display the selected object indicator 614 and/or the second content item 630 of the user interface 600.

V. Example Systems for Selectively Displaying Content

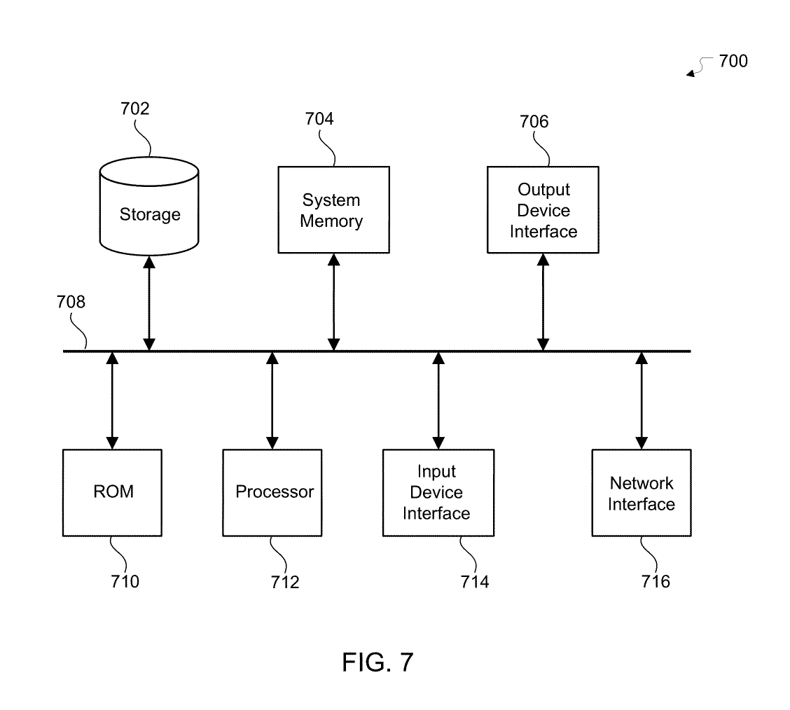

FIG. 7 conceptually illustrates electronic system 700 with which any implementations of the subject technology may be implemented. Electronic system 700, for example, can be a desktop computer, a laptop computer, a tablet computer, a server, a switch, a router, a base station, a receiver, a phone, a personal digital assistant (PDA), or generally any electronic device that transmits signals over a network. Such an electronic system includes various types of computer readable media and interfaces for various other types of computer readable media. Electronic system 700 includes bus 708, processing unit(s) 712, system memory 704, read-only memory (ROM) 710, permanent storage device 702, input device interface 714, output device interface 706, and network interface 716, or subsets and variations thereof.

Bus 708 collectively represents all system, peripheral, and chipset buses that communicatively connect the numerous internal devices of electronic system 700. In one or more implementations, bus 708 communicatively connects processing unit(s) 712 with ROM 710, system memory 704, and permanent storage device 702. From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. One or more implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such as random access memory. System memory 704 stores any of the instructions and data that processing unit(s) 712 needs at runtime. In one or more implementations, the processes of the subject disclosure are stored in system memory 704, permanent storage device 702, and/or ROM 710. From these various memory units, processing unit(s) 712 retrieves instructions to execute and data to process in order to execute the processes of one or more implementations.

Bus 708 also connects to input and output device interfaces 714 and 706. Input device interface 714 enables a user to communicate information and select commands to the electronic system. Input devices used with input device interface 714 include, for example, alphanumeric keyboards and pointing devices (also called “cursor control devices”). Output device interface 706 enables, for example, the display of images generated by electronic system 700. Output devices used with output device interface 706 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, bus 708 also couples electronic system 700 to a network (not shown) through network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method for selectively displaying content, the method comprising:
displaying, using one or more computing devices, a graphical object on a map at a first location;
determining, using the one or more computing devices, a user interaction with the graphical object;
displaying, using the one or more computing devices and in response to the determining, a first content item on the map at a second location that is proximal to the first location, wherein the first content item is associated with the graphical object;
identifying, using the one or more computing devices, a selection of the graphical object;
displaying, using the one or more computing devices and in response to the identifying, a second content item on the map at a third location that is disparate from the first and second locations, wherein the second content item is associated with the first content item and the graphical object; and
transmitting an indication of the selection of the graphical object.

2. The method of claim 1, wherein the first content item comprises an advertisement for a business associated with the graphical object.

3. The method of claim 2, wherein the second content item comprises at least one of an address or a telephone number of the business associated with the graphical object.

4. The method of claim 3, wherein the indication indicates that a click-through should be charged to the business associated with the graphical object.

5. The method of claim 1, wherein the first content item is displayed on the map exclusively while the user interaction is occurring.

6. The method of claim 5, wherein the user interaction comprises a hover interaction.

7. The method of claim 1, wherein the displaying, using the one or more computing devices and in response to the identifying, the second content item on the map at the third location further comprises replacing, using the one or more computing devices and in response to the identifying, a third content item on the map at the third location with the second content item.

8. The method of claim 1 further comprising replacing, using the one or more computing devices and in response to the identifying, the graphical object with a selected object indicator.

9. A computer-implemented method for providing selectively displayable content, the method comprising:
providing, using one or more computing devices, a graphical object to be displayed on a map at a first location and first and second content items that are associated with the graphical object, the first content item to be displayed on the map at a second location that is proximal to the first location and the second content item to be displayed on the map at a third location that is disparate from the first and second locations, wherein the second content item is to be displayed exclusively in response to a selection of the graphical object by a user;
receiving, using the one or more computing devices, an indication of the selection of the graphical object by the user; and
storing, using the one or more computing devices, the indication of the selection of the graphical object by the user.

10. The method of claim 9, wherein the graphical object is associated with a business, the first content item comprises an advertisement for the business, and the second content item comprises information regarding the business.

11. The method of claim 10, wherein the information comprises at least one of a phone number of the business, an address of the business, or a uniform resource locator of the business.

12. The method of claim 10, further comprising charging, using the one or more computing devices, a click-through fee to the business associated with the graphical object upon receiving the indication of the selection of the graphical object by the user.

13. The method of claim 9, wherein the third location of the second content item is non-adjacent to, and non-overlapping with, the second location of the first content item.

14. The method of claim 9, wherein the first content item is to be displayed on the map exclusively in response to identifying a hover interaction with the graphical object.

15. A system, comprising:
one or more processors; and
a memory including instructions that, when executed by the one or more processors, cause the one or more processors to:
receive an advertisement and a content item, wherein the advertisement is associated with the content item;
display the advertisement on a web page;
identify a selection of the advertisement;
display, in response to the identify, the content item on the web page, wherein the content item is displayed non-adjacent to, and non-overlapping with, the advertisement; and
transmit, in response to the selection, an indication of a click-through of the advertisement.

16. The system of claim 15, wherein the instructions, when executed by the one or more processors, further cause the one or more processors to display a map on the web page, wherein the advertisement and the content item are displayed on the map.

17. The system of claim 16, wherein the advertisement comprises a graphical object that is displayed on the map.

18. The system of claim 17, wherein the advertisement is associated with a business and the content item comprises at least one of a phone number or an address of the business.

19. A non-transitory machine readable medium embodying instructions that, when executed by a machine, cause the machine to perform a method for selectively displaying content, the method comprising:
receiving a graphical object and first and second content items associated with the graphical object;
displaying the graphical object on a map at a first position;
displaying the first content item on the map at a second position that is proximal to the first position;
identifying a selection of the graphical object; and
displaying, in response to the identifying, the second content item on the map at a third position that is disparate from the first and second positions.

20. The non-transitory machine readable medium of claim 19, wherein the method further comprises transmitting an indication of the selection of the graphical object.

21. The non-transitory machine readable medium of claim 20, wherein the indication is indicative of a click-through with respect to the graphical object.

22. The non-transitory machine readable medium of claim 19, wherein the first content item comprises an advertisement for a business associated with the graphical object and the second content item comprises business information for the business associated with the graphical object.

23. The non-transitory machine readable medium of claim 19, wherein the displaying the first content item on the map at the second position that is proximal to the first position further comprises displaying the first content item on the map at the second position that is proximal to the first position exclusively in response to identifying a user interaction with the graphical object.

24. The non-transitory machine readable medium of claim 23, wherein the user interaction comprises a hover interaction.

25. The non-transitory machine readable medium of claim 19, wherein the displayed second content item is non-adjacent to, and non-overlapping with, the displayed first content item.
